(19) United States
(12) Patent Application Publication
(10) Pub. No.: US 2024/0211019 A1
(43) Pub. Date: Jun. 27, 2024

(54) RUNTIME-LEARNING GRAPHICS POWER OPTIMIZATION

(71) Applicant: Advanced Micro Devices, Inc., Santa Clara, CA (US)

(72) Inventors: Rashad Oreifej, Orlando, FL (US); Sokratis Dimitriadis, Santa Clara, CA (US); Tzyy-Juin Kao, Santa Clara, CA (US); Xiayu Xu, Santa Clara, CA (US)

(21) Appl. No.: 18/146,776

(22) Filed: Dec. 27, 2022

(51) Int. Cl. G06F 1/329

(52) U.S. Cl. CPC G06F 1/329

(57) ABSTRACT

Systems, apparatuses, and methods for implementing runtime-learning graphics power optimization are illustrated. A system management unit monitors tasks queued for a computing component, such as a central processing unit (CPU) or a graphics processing unit (GPU). The system management unit computes a total number of clock cycles consumed to execute a first task. The system management unit then determines a second task for execution and modifies a current operating frequency by a given percentage while executing the second task. The system management unit determines the number of clock cycles that execution of the second task consumed and compares this to the number of clock cycles for the first task. Based at least in part on the comparison, the system management unit computes a performance sensitivity of tasks similar to the first and second tasks.

### BACKGROUND

### Description of the Related Art

Conventionally, frequency selection during execution of a workload at a CPU or a GPU is performed in order to maximize performance and minimize power consumption. In order to select the optimal frequency, current power management techniques require profiling of the workload at runtime and then finding the optimal frequencies by applying a frequency selection model against the profiled workload. This frequency selection model is built offline and trained with real-world application profiling data collected through directed runs offline.

However, these techniques suffer from multiple shortcomings. The profiling of workloads using a frequency selection model is tedious and time-consuming, since data collection process is done at the time of manufacture and needs to be redone for each individual unit. Further, the frequency model building requires stable hardware and software stack and may be sensitive to post-silicon tuning that occurs in later stages close to production. This may leave limited time to rebuild the model, if such a requirement arises. Furthermore, the quality and accuracy of the model is highly dependent on the quality and coverage of the training data. As the model is built to be generic enough to fit most applications, it may suffer from reduced efficiency in saving power in favor for performance conservation.

In view of the above, improved systems and methods for frequency optimization in graphics processing systems are required.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 is a block diagram of another implementation of a computing system.

FIG. 3 is a block diagram of a one implementation of a task scheduler.

FIG. 4 illustrates an exemplary method for computation of performance sensitivity of one or more tasks to operating frequencies.

FIG. 5 illustrates an exemplary spectrum of performance sensitivity of various tasks to operating frequencies.

FIG. 6 illustrates an exemplary method

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for computing performance sensitivities for computing units are disclosed. A system management unit monitors draw calls targeted at a computing component, such as a central processing unit (CPU) or a graphics processing unit (GPU). In response to a determination that a first draw call has been queued for execution, the system management unit computes a total number of clock cycles it takes to execute the first draw call. The system management unit then determines a second draw call for execution and modifies a current operating frequency by a given percentage while executing the second draw call. The system management unit determines the number of clock cycles that execution of the second draw call consumed and compares this to the number of clock cycles for the first draw call. Based at least in part on the comparison, the system management unit computes a performance sensitivity of execution of one or more draw calls to changes in operating frequencies. As an example, a system management unit may be a system management circuit or system management circuitry.

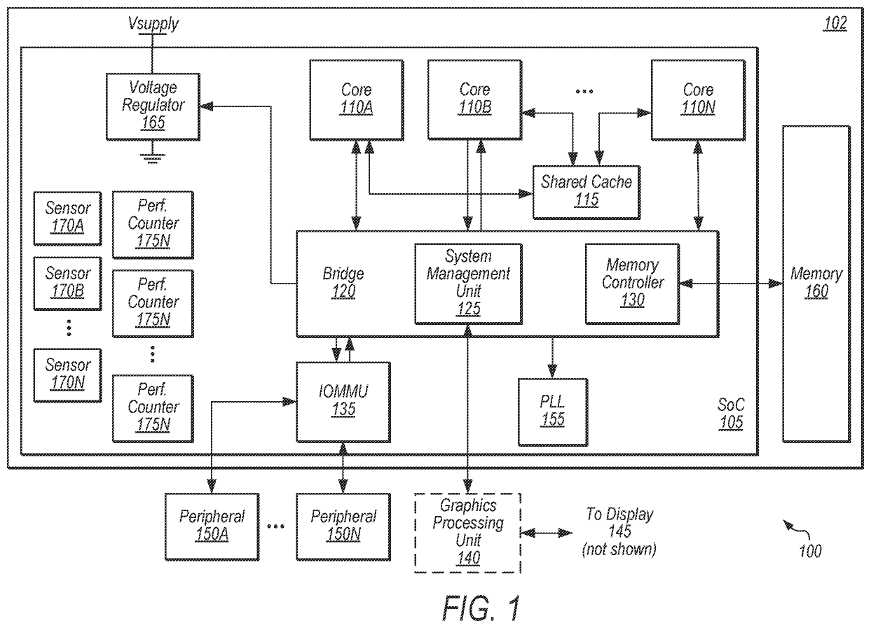

Referring now to FIG. 1, a block diagram of one implementation of a computing system 100 is shown. In this implementation, the illustrated computing system 100 includes system on a chip (SoC) 105 coupled to memory 160. However, implementations in which one or more of the illustrated components of the SoC 105 are not integrated onto a single chip are possible and are contemplated. In some implementations, SoC 105 includes a plurality of processor cores 110A-N and GPU 140. In the illustrated implementation, the SoC 105, Memory 160, and other components (not shown) are part of a system board 102, and one or more of the peripherals 150A-150N and GPU 140 are discrete entities (e.g., daughter boards, etc.) that are coupled to the system board 102. In other implementations, GPU 140 and/or one or more of Peripherals 150 may be permanently mounted on system board 102 or otherwise integrated into SoC 105. It is noted that processor cores 110A-N can also be referred to as processing units or processors. Processor cores 110A-N and GPU 140 are configured to execute instructions of one or more instruction set architectures (ISAs), which can include operating system instructions and user application instructions. These instructions include memory access instructions which can be translated and/or decoded into memory access requests or memory access operations targeting memory 160.

In another implementation, SoC 105 includes a single processor core 110. In multi-core implementations, processor cores 110 can be identical to each other (i.e., symmetrical multi-core), or one or more cores can be different from others (i.e., asymmetric multi-core). Each processor core 110 includes one or more execution units, cache memories, schedulers, branch prediction circuits, and so forth. Furthermore, each of processor cores 110 is configured to assert requests for access to memory 160, which functions as main memory for computing system 100. Such requests include read requests, and/or write requests, and are initially received from a respective processor core 110 by bridge 120. Each processor core 110 can also include a queue or buffer that holds in-flight instructions that have not yet completed execution. This queue can be referred to herein as an “instruction queue.” Some of the instructions in a processor core 110 can still be waiting for their operands to become available, while other instructions can be waiting for an available arithmetic logic unit (ALU). The instructions which are waiting on an available ALU can be referred to as pending ready instructions. In one implementation, each processor core 110 is configured to track the number of pending ready instructions.

Input/output memory management unit (IOMMU) 135 is coupled to bridge 120 in the implementation shown. In one implementation, bridge 120 functions as a northbridge device and IOMMU 135 functions as a southbridge device in computing system 100. In other implementations, bridge 120 can be a fabric, switch, bridge, any combination of these components, or another component. A number of different types of peripheral buses (e.g., peripheral component interconnect (PCI) bus, PCI-Extended (PCI-X), PCIE (PCI Express) bus, gigabit Ethernet (GBE) bus, universal serial bus (USB)) can be coupled to IOMMU 135. Various types of peripheral devices 150A-N can be coupled to some or all of the peripheral buses. Such peripheral devices 150A-N include (but are not limited to) keyboards, mice, printers, scanners, joysticks or other types of game controllers, media recording devices, external storage devices, network interface cards, and so forth. At least some of the peripheral devices 150A-N that are coupled to IOMMU 135 via a corresponding peripheral bus can assert memory access requests using direct memory access (DMA). These requests (which can include read and write requests) are conveyed to bridge 120 via IOMMU 135.

In some implementations, SoC 105 includes a graphics processing unit (GPU) 140 configured to be coupled to display 145 (not shown) of computing system 100. In some implementations, GPU 140 is an integrated circuit that is separate and distinct from SoC 105. GPU 140 performs various video processing functions and provides the processed information to display 145 for output as visual information. GPU 140 can also be configured to perform other types of tasks scheduled to GPU 140 by an application scheduler. GPU 140 includes a number ‘N’ of compute units for executing tasks of various applications or processes, with ‘N’ a positive integer. The ‘N’ compute units of GPU 140 is also be referred to as “processing units”. Each compute unit of GPU 140 is configured to assert requests for access to memory 160.

In one implementation, memory controller 130 is integrated into bridge 120. In other implementations, memory controller 130 is separate from bridge 120. Memory controller 130 receives memory requests conveyed from bridge 120. Data accessed from memory 160 responsive to a read request is conveyed by memory controller 130 to the requesting agent via bridge 120. Responsive to a write request, memory controller 130 receives both the request and the data to be written from the requesting agent via bridge 120. If multiple memory access requests are pending at a given time, memory controller 130 arbitrates between these requests. For example, memory controller 130 can give priority to critical requests while delaying non-critical requests when the power budget allocated to memory controller 130 restricts the total number of requests that can be performed to memory 160.

In some implementations, memory 160 includes a plurality of memory modules. Each of the memory modules includes one or more memory devices (e.g., memory chips) mounted thereon. In some implementations, memory 160 includes one or more memory devices mounted on a motherboard or other carrier upon which SoC 105 is also mounted. In some implementations, at least a portion of memory 160 is implemented on the die of SoC 105 itself. Implementations having a combination of the aforementioned implementations are also possible and contemplated. In one implementation, memory 160 is used to implement a random access memory (RAM) for use with SoC 105 during operation. The RAM implemented can be static RAM (SRAM) or dynamic RAM (DRAM). The type of DRAM that is used to implement memory 160 includes (but are not limited to) double data rate (DDR) DRAM, DDR2 DRAM, DDR3 DRAM, and so forth.

Although not explicitly shown in FIG. 1, SoC 105 can also include one or more cache memories that are internal to the processor cores 110. For example, each of the processor cores 110 can include an L1 data cache and an L1 instruction cache. In some implementations, SoC 105 includes a shared cache 115 that is shared by the processor cores 110. In some implementations, shared cache 115 is a level two (L2) cache. In some implementations, each of processor cores 110 has an L2 cache implemented therein, and thus shared cache 115 is a level three (L3) cache. Cache 115 can be part of a cache subsystem including a cache controller.

In various implementations, system management unit 125 is part of the GPU 140. In other implementation, circuitry associated with the system management unit 125 is integrated into bridge 120, can be separate from bridge 120, and/or system management unit 125 can be implemented as multiple, separate components in multiple locations of SoC 105. System management unit 125 is configured to manage the power states of the various processing units of SoC 105. In one implementation, system management unit 125 uses dynamic voltage and frequency scaling (DVFS) to change the frequency and/or voltage of a processing unit to limit the processing unit's power consumption to a chosen power allocation.

SoC 105 includes multiple temperature sensors 170A-N, which are representative of any number of temperature sensors. It should be understood that while sensors 170A-N are shown on the left-side of the block diagram of SoC 105, sensors 170A-N can be spread throughout the SoC 105 and/or can be located next to the major components of SoC 105 in the actual implementation of SoC 105. In one implementation, there is a sensor 170A-N for each core 110A-N, compute unit of GPU 140, and other major components. In this implementation, each sensor 170A-N tracks the temperature of a corresponding component. In another implementation, there is a sensor 170A-N for different geographical regions of SoC 105. In this implementation, sensors 170A-N are spread throughout SoC 105 and located so as to track the temperatures in different areas of SoC 105 to monitor whether there are any hot spots in SoC 105. In other implementations, other schemes for positioning the sensors 170A-N within SoC 105 are possible and are contemplated.

SoC 105 also includes multiple performance counters 175A-N, which are representative of any number and type of performance counters. It should be understood that while performance counters 175A-N are shown on the left-side of the block diagram of SoC 105, performance counters 175A-N can be spread throughout the SoC 105 and/or can be located within the major components of SoC 105 in the actual implementation of SoC 105. For example, in one implementation, each core 110A-N includes one or more performance counters 175A-N, memory controller 130 includes one or more performance counters 175A-N, GPU 140 includes one or more performance counters 175A-N, and other performance counters 175A-N are utilized to monitor the performance of other components. Performance counters 175A-N can track a variety of different performance metrics, including the instruction execution rate of cores 110A-N and GPU 140, consumed memory bandwidth, row buffer hit rate, cache hit rates of various caches (e.g., instruction cache, data cache), and/or other metrics.

In one implementation, SoC 105 includes a phase-locked loop (PLL) unit 155 coupled to receive a system clock signal. PLL unit 155 includes a number of PLLs configured to generate and distribute corresponding clock signals to each of processor cores 110 and to other components of SoC 105. In one implementation, the clock signals received by each of processor cores 110 are independent of one another. Furthermore, PLL unit 155 in this implementation is configured to individually control and alter the frequency of each of the clock signals provided to respective ones of processor cores 110 independently of one another. The frequency of the clock signal received by any given one of processor cores 110 can be increased or decreased in accordance with power states assigned by system management unit 125. The various frequencies at which clock signals are output from PLL unit 155 correspond to different operating points for each of processor cores 110. Accordingly, a change of operating point for a particular one of processor cores 110 is put into effect by changing the frequency of its respectively received clock signal.

An operating point for the purposes of this disclosure can be defined as an operating frequency (or clock frequency), and can also include an operating voltage (e.g., supply voltage provided to a functional unit). Increasing an operating point for a given functional unit can be defined as increasing the clock frequency provided to that unit and can also include increasing its operating voltage. Similarly, decreasing an operating point for a given functional unit can be defined as decreasing the clock frequency, and can also include decreasing the operating voltage. Limiting an operating point can be defined as limiting the clock frequency and/or operating voltage to specified maximum values for particular set of conditions (but not necessarily maximum limits for all conditions). Thus, when an operating point is limited for a particular processing unit, it can operate at a clock frequency and operating voltage up to the specified values for a current set of conditions, but can also operate at clock frequency and operating voltage values that are less than the specified values.

In the case where changing the respective operating points of one or more processor cores 110 includes changing of one or more respective clock frequencies, system management unit 125 changes the state of digital signals provided to PLL unit 155. Responsive to the change in these signals, PLL unit 155 changes the clock frequency of the affected processing core(s) 110. Additionally, system management unit 125 can also cause PLL unit 155 to inhibit a respective clock signal from being provided to a corresponding one of processor cores 110.

In the implementation shown, SoC 105 also includes voltage regulator 165. In other implementations, voltage regulator 165 can be implemented separately from SoC 105. Voltage regulator 165 provides a supply voltage to each of processor cores 110 and to other components of SoC 105. In some implementations, voltage regulator 165 provides a supply voltage that is variable according to a particular operating point. In some implementations, each of processor cores 110 shares a voltage plane. Thus, each processing core 110 in such an implementation operates at the same voltage as the other ones of processor cores 110. In another implementation, voltage planes are not shared, and thus the supply voltage received by each processing core 110 is set and adjusted independently of the respective supply voltages received by other ones of processor cores 110. Thus, operating point adjustments that include adjustments of a supply voltage can be selectively applied to each processing core 110 independently of the others in implementations having non-shared voltage planes. In the case where changing the operating point includes changing an operating voltage for one or more processor cores 110, system management unit 125 changes the state of digital signals provided to voltage regulator 165. Responsive to the change in the signals, voltage regulator 165 adjusts the supply voltage provided to the affected ones of processor cores 110. In instances when power is to be removed from (i.e., gated) one of processor cores 110, system management unit 125 sets the state of corresponding ones of the signals to cause voltage regulator 165 to provide no power to the affected processing core 110.

In various implementations, computing system 100 can be a computer, laptop, mobile device, server, web server, cloud computing server, storage system, or any of various other types of computing systems or devices. It is noted that the number of components of computing system 100 and/or SoC 105 can vary from implementation to implementation. There can be more or fewer of each component/subcomponent than the number shown in FIG. 1. It is also noted that computing system 100 and/or SoC 105 can include other components not shown in FIG. 1. Additionally, in other implementations, computing system 100 and SoC 105 can be structured in other ways than shown in FIG. 1.

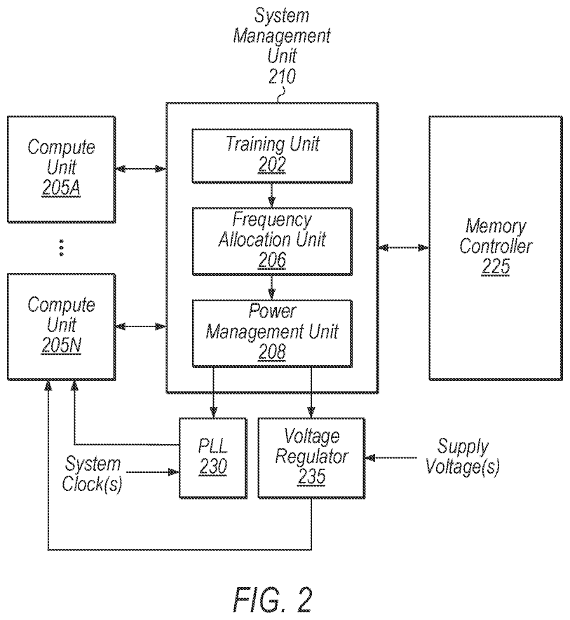

Turning now to FIG. 2, a block diagram of one implementation of a system management unit 210 is shown. System management unit 210 is coupled to compute units 205A-N, memory controller 225, phase-locked loop (PLL) unit 230, and voltage regulator 235. System management unit 210 can also be coupled to one or more other components not shown in FIG. 2. Compute units 205A-N are representative of any number and type of compute units (e.g., CPU, GPU, FPGA, etc.), and compute units 205A-N may also be referred to as processors or processing units. In some implementations, compute units include either or both of general purpose and special purpose computing circuitry. For example, in one implementation, at least one compute unit is a central processing unit (CPU) and another compute unit is a graphics processing unit (GPU).

System management unit 210 includes training unit 202, frequency allocation unit 206, and performance management unit 208. Frequency allocation unit 206 is configured to allocate operating frequencies (i.e., clock frequencies) to each of compute units 205A-N, to a memory subsystem including memory controller 225, and/or to one or more other components. In an implementation, the operating frequencies allocated by the frequency allocation unit 206 may be determined based at least in part on a total amount of power available to system management unit 210 to be dispersed to the components and the power can be capped for the host system. Frequency allocation unit 206 receives various inputs from compute units 205A-N including a status of the miss status holding registers (MSHRs) of compute units 205A-N, the instruction execution rates of compute units 205A-N, the number of pending ready-to-execute instructions in compute units 205A-N, the instruction and data cache hit rates of compute units 205A-N, the consumed memory bandwidth, and/or one or more other input signals. Frequency allocation unit 206 can utilize these inputs to determine whether compute units 205A-N have tasks to execute, and can adjust the operating frequencies allocated to compute units 205A-N according to these determinations.

PLL unit 230 receives system clock signal(s) and includes any number of PLLs configured to generate and distribute corresponding clock signals to each of compute units 205A-N and to other components. Performance management unit 208 is configured to convey control signals to PLL unit 230 to control the clock frequencies supplied to compute units 205A-N and to other components. Voltage regulator 235 provides a supply voltage to each of compute units 205A-N and to other components. Performance management unit 208 is configured to convey control signals to voltage regulator 235 to control the voltages supplied to compute units 205A-N and to other components. Memory controller 225 is configured to control the memory (not shown) of the host computing system or apparatus. For example, memory controller 225 issues read, write, erase, refresh, and various other commands to the memory.

In an exemplary implementation, the system management unit 210 manages operating frequencies and power consumption for the system in an optimization mode. For instance, in the optimization mode, the system management unit 210 drops operating frequency of a computing unit when executing tasks that have low performance sensitivity (or relatively lower sensitivity to other tasks) to clock frequencies, in order to save power. For example, for a computing unit executing tasks that are compute-bound, the system management unit 210 increases the clock frequency to improve performance. On the other hand, for memory-bound tasks, the system management unit 210 does not increase the frequency given that such an increase does not result in an increased (or desired increase) in performance.

In an implementation, the training unit 202 determines performance sensitivity of a given task (e.g., draw calls) to changes in operating frequencies during runtime as opposed to while being offline (i.e., while executing test bench or other data), based at least in part on learnt frequency profiles for one or more similar tasks. As described herein, in a non-limiting example, when the given task comprises rendering of a frame, two frames are relatively similar if both frames are of the same length. As referred to hereinafter, a length of a frame is defined as a length of time it takes to render the frame. Similarly, two or more draw calls in a given frame may be deemed similar if they consume an equal or substantially equal number of clock cycles during execution. In various implementations, a substantially equal number of clock cycles consumed during execution of tasks can mean the number of clock cycles consumed during execution of the tasks is equal, or the number of clock cycles consumed during execution of the tasks is within a programmable or predetermined number of one another (e.g., the change is less than a threshold amount, a percentage change is less than some threshold, etc.).

Training unit 202 is configured to identify a given task to be profiled, e.g., a draw call of a frame in a given scene, and determine performance sensitivity of the given task to changes in operating frequencies. The operating frequencies and power consumption at which the computing unit executes the given task can be optimized by the performance management unit 208, based on the computed performance sensitivity. In one implementation, in order to compute performance sensitivity of the one or more tasks, the training unit 202 can profile a given task. In order to profile a given task, the training unit first determines a number of clock cycles a computing unit consumes while executing the given task. Next, for a subsequent task, the frequency allocation unit 206 modifies an operating frequency and the training unit determines the number of clock cycles consumed for execution of the subsequent task. Based on the change in the number of clock cycles (or lack thereof), the training unit may determine performance sensitivity for the tasks to changes in operating frequencies. The process of profiling one or more tasks is hereinafter referred to as the “training phase.”

Once the training phase is complete, the frequency allocation unit 206 adjusts the operating frequencies while executing one or more subsequent tasks. In an implementation, for tasks having higher performance sensitivity to changes in operating frequencies than one or more other tasks, the frequency allocation unit 206 can increase the operating frequency in order to increase performance. Similarly, if the operating frequencies for such tasks are reduced, the performance may decrease. On the other hand, for tasks having relatively lower performance sensitivities than one or more other tasks, the changes in operating frequencies may not affect the performance in execution of such tasks. In such a scenario, the performance may be dependent on one or more limitations, such as external memory latencies. Each distinct task may have a specific performance sensitivity to changes in operating frequencies. The process of adjusting operating frequencies to dictate power consumption and affect performance of execution of a given task is hereinafter referred to as the “optimization phase.”

In an implementation, the training unit 202 triggers the training phase each time a distinct task is encountered at a given computing unit. In an example, when one or more tasks include rendering of multiple scenes, each having multiple frames, the training unit 202 can trigger recording every time the scene changes (e.g., during runtime). In one example, a change in an amount of time taken to render a frame (i.e., length of the frame), from a previously rendered frame, may be indicative of a change in the scene. Each new scene, in one example, can include multiple frames each containing one or more “long” draw calls. In an implementation, a draw call can be identified as a long draw call if the execution of the draw call, takes or is predicted to take more than a given number of clock cycles. For example, in some implementations a comparison in the number of cycles it takes to render frames is compared to determine if a scene change has occurred. If the number of cycles is less than some amount (e.g., 10,000 cycles or some other number that may be programmable), then the frames may be deemed sufficiently similar that a scene change has not occurred (or is deemed not to have occurred). If the difference exceeds such a value, then a scene change is deemed to have occurred. Various such implementations are possible and are contemplated. In yet another implementation, if a plurality of draw calls consumes an average number of clock cycles, and a given draw call falls into an n^{th} percentile or higher in terms of predicted number of clock cycles, that given draw call may be considered as long. Draw calls, including long draw calls, can be identified based at least in part on a unique identifier associated with a shader program defining the execution instructions for the frame, and/or a process identifier (ID), or otherwise. In one exemplary implementation, identification information regarding draw calls can be obtained via the shader program or shader block(s), e.g., via data received or retrieved from the shader program or the shader block(s). For example, the shader block(s) may include instrumentation supporting identification of various draw calls, their execution times, unique identifiers used to distinguish draw calls, predicted number of clock cycles, and the like. In various implementations, such identification information is stored and is accessible to the system management unit 210 (and/or other units). In another implementation, the shader block(s) may be further configured to allocate workload to a graphics pipeline as well as track the launch of one or more draw calls, and their subsequent executions. Other implementations are contemplated.

In an example, the training unit 202 can store data associated with the profiled draw calls at a specific memory location, such as in a data array (or other memory location) and used by the frequency allocation unit 206 to dictate operating frequencies for other similar draw calls subsequently encountered for execution. That is, the data associated with the profiled draw calls can serve as reference operating point(s) for the system management unit 210 to determine operating frequencies for execution of other subsequent draw calls. This data is hereinafter referred to as the “profiling data.” In an implementation, the system management unit 210 uses the profiling data to manage power and frequency consumption of one or more computing units during execution of the draw calls. In one implementation, the system management unit 210 uses runtime low-power controller (RLC) firmware or software to execute programmable instructions for determining power and frequency consumption of a given computing unit, based at least in part on the profiling data. Further, the system management unit 210 can also utilize the RLC firmware to communicate with the shader block(s) for accessing information pertaining to draw calls and their execution.

Using the profiling data may advantageously facilitate removal of the need for building a frequency selection model, since systems and methods described herein substitute such models with a self-learning training model carried out at run-time. Further, using such training models may save effort and time during silicon work as no pre-training and modeling may be required to find optimal operating frequencies. As used herein, an “optimal” operating frequency is a frequency identified as being more efficient than another frequency for a given task. For example, if a task operating at two different frequencies has a same (or largely same) performance, then using the higher frequency may be deemed less efficient due to consumption of additional power for little to no benefit. In this case, the lower frequency would be deemed to be the optimal frequency because of its better power/performance characteristics. Even if another frequency exists that has better power/performance characteristics than the lower frequency that was selected (e.g., another frequency not tested), this lower frequency is deemed the optimal frequency as it has been identified as such during the training process. The operating frequencies, as described herein, can also more accurately match the operating conditions of the computing systems, than that of conventional frequency modeling techniques. These run-time training and optimization phases can also be easier to scale across various workloads and computing systems.

Although the systems and methods described herein are explicated with regards to profiling of draw calls while rendering frames of a given scene, in various alternate implementations, such profiling may be performed for tasks other than graphics processing and profiling data generated as a result may be utilized in optimizing processing units other than graphics processing units. Such implementations are contemplated.

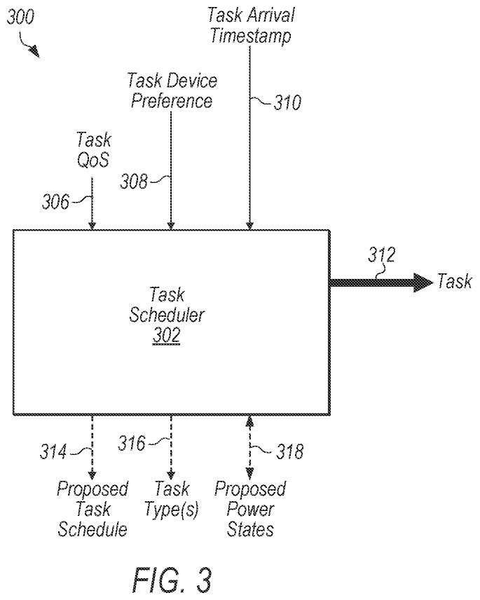

Referring now to FIG. 3, one implementation 300 of a task scheduler is shown. In one implementation, a task scheduler 302 assigns tasks from a task queue to a plurality of compute units of a SoC (e.g., SoC 105 of FIG. 1). The task scheduler 302 receives a plurality of inputs to use in determining how to schedule tasks to the various compute units of the SoC. The task scheduler 302 also coordinates with a system management unit (e.g., system management unit 210 of FIG. 2) to determine an optimal task schedule for the pending tasks to the compute units of the SoC. The plurality of inputs utilized by the task scheduler 302 includes quality of service (QoS) 306 requirement of the queued tasks, task arrival timestamp 310, and respective device preferences 308 (e.g., CPU, GPU). In other implementations, the task scheduler 302 utilizes other inputs to determine an optimal task schedule 314 for the pending tasks 312. In various implementations, information regarding proposed task schedules 314 and task types 316 is conveyed to, or otherwise make available to, system management unit 210.

In one implementation, the task scheduler 302 attempts to minimize execution time of the tasks on their assigned compute units and the wait time of the tasks such that the temperature increase of the compute units executing their assigned tasks stays below the temperature margin currently available. The task scheduler 302 also attempts to schedule tasks to keep the sum of the execution time of a given task plus the wait time of the given task less than or equal to the time indicated by the QoS setting of the given task. In other implementations, other examples of algorithms for a task scheduler are possible and are contemplated.

In another implementation, the system management unit 210 uses device preferences 308 to determine whether a given task is compute-bound or memory-bound. Further, the system management unit 210 ascertains the power state of a computing unit for executing the given task 312 from proposed power states 318. Based on the information on whether the task 312 is compute or memory bound, and the power state of the computing unit, the performance management unit 208 manages performance with respect to allocated power for the computing unit executing the task 312. Further, based on the allocated power and the devices preferences 308, the frequency allocation unit 206 is configured to manage the operating frequencies for the computing unit, i.e., either by increasing the operating frequencies, decreasing the operating frequencies, or keeping the operating frequencies constant.

In one example, for tasks having relatively lower performance sensitivity to changes in operating frequencies, frequency allocation unit 206 may keep the operating frequencies constant, since changes in the operating frequencies would not affect performance to a desired extent. However, for tasks having relatively higher performance sensitivity to changes in operating frequencies, the frequency allocation unit 206 may increase the operating frequencies while executing such a task in order to boost performance (or decrease operating frequencies when power saving is desirable over performance boost).

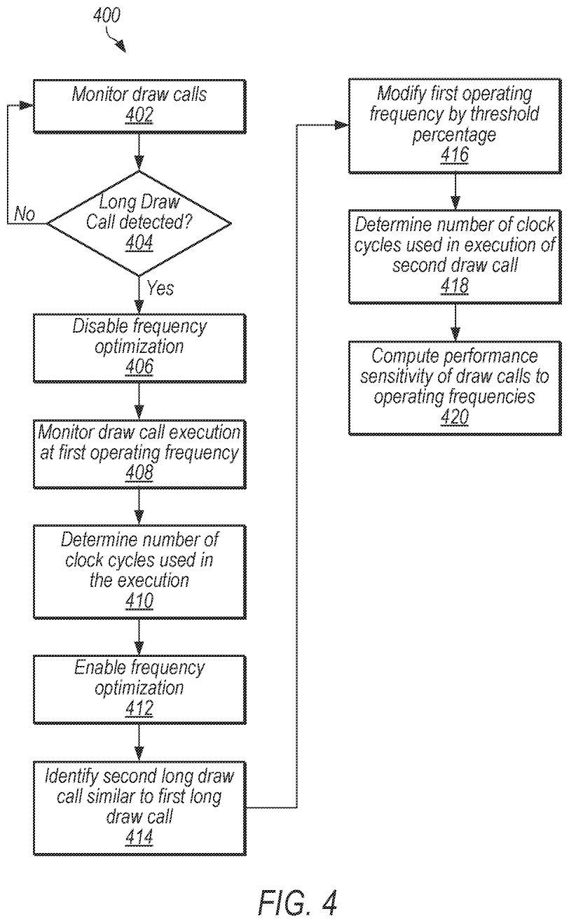

Turning now to FIG. 4, an exemplary method 400 a method for computation of performance sensitivity of one or more tasks to operating frequencies is illustrated. As described earlier, a system management unit (e.g., system management unit 210 of FIG. 2) is configured to operate in a training phase and an optimization phase, such that in the training phase the system management unit profiles one or more tasks for their respective sensitivities to changes in a given parameter (e.g., operating frequency). Further, in the optimization phase, the system management uses profiling data generated during the training phases to optimize power consumption of a computing unit(s), based on modifications to operating frequencies, for execution of other tasks relatively similar to the profiled tasks. In an implementation, the system management unit is configured to operate in the training phase during runtime and does not require profiling of the tasks to be performed offline, thereby reducing changes occurring due to post-silicon tuning of the SoC.

For the sake of brevity, method 400 is described using an example in which the one or more tasks to be profiled include draw calls executed during rendering of a given frame of a scene. Each time a scene changes, the system management unit retriggers the training phase and profiling data is updated. The profiling data is used to optimize operating frequencies to manage power consumption of computing units executing tasks similar to the profiled tasks, during an optimization phase. That is, the system management unit may continue cyclic operations between various training phases and optimization phases. Other examples are contemplated.

A system management unit monitors one or more draw calls queued for execution during rendering of frames in a scene (block 402). In an implementation, the system management unit monitors the draw calls in order to identify long draw calls. As described in the foregoing, a draw call is identified as a long draw call based at least in part on a unique identifier associated with a shader program defining the execution instructions for the frame. In another implementation, a draw call is defined as a “long” draw call if the execution of the draw call is predicted to take more than a threshold number of clock cycles, where the threshold may be programmable. It is noted that if the threshold is set to zero, then all draw calls can be profiled. However, such an approach may require too much overhead to be practical. Further, the processing time of a frame is dominated by long draw calls and in this sense the long draw calls may be representative of a critical path. Therefore, by profiling only a subset of draw calls (e.g., the long draw calls), improvement in performance can be achieved without incurring undue overhead. Other implementations are contemplated.

The system management unit then determines whether a long draw call is detected (conditional block 404). In case no long draw calls have been detected (conditional block 404, “no” leg), the system management unit continues to monitor draw calls until such a long draw call is detected. When a first long draw call (or “first draw call”) is detected (conditional block 404, “yes” leg), the system management unit can trigger the training phase and disable the frequency optimization for a computing unit scheduled to execute the first draw call, i.e., the optimization mode is turned off (block 406). In an implementation, the frequency optimization mode may be turned off in order to ensure that no changes to operating frequencies are made when the first draw call is being profiled in the training mode. In the implementations described herein, the disablement of optimization mode refers to disabling optimizations to frequency for one or more memory bound tasks, i.e., changes in operating frequencies provided to computing unit(s) executing the memory-bound tasks. However, other power management functions such as dynamic power management for one or more GPU cores, GPU deep sleep functions, clock-gating, and the like, may be active even when the optimization mode is disabled.

During the training phase, with the optimization mode disabled, the system management unit monitors execution of the first draw call at a first operating frequency (block 408) to determine a number of clock cycles consumed by the computing unit to execute the draw call (block 410). In one implementation, the number of clock cycles taken to execute the first draw call is stored as part of the profiling data in a specific memory location by the system management unit. Once the number of clock cycles are determined, the system management unit enables the frequency optimizations again, i.e., enables the optimization mode (block 412).

The system management unit then identifies a second long draw call (or “second draw call”), similar to the first draw call (block 414). In an implementation, the second draw call is similar to the first draw call in that the second draw call is also queued for execution during rendering of the same frame as the first draw call. In another implementation, the second draw call can be identified while rendering a subsequent frame of the same scene comprising the frame for which the first draw call was identified.

For execution of the second draw call, the system management unit modifies the first operating frequency (block 416) to produce a second operating frequency. In one implementation the modification is by a given amount or percentage (either of which may be programmable), though other implementations are possible and are contemplated. That is, the system management unit can increase or decrease the first operating frequency by a given percentage while executing the second draw call. The system management unit again determines the number of clock cycles consumed by a computing unit executing the second draw call at the second operating frequency (block 418). This determined number is also stored as a part of profiling data.

The system management unit, in one implementation, computes the performance sensitivity to operating frequencies for the draw calls (block 420), based at least on a comparison of respective number of clock cycles consumed during execution of the first draw call and the second draw call, at the first operating frequency and the second operating frequency, respectively. For example, if the number of clock cycles does not change (or changes minimally) even when the frequency is modified from the first frequency to the second frequency, it can be indicative of a higher performance sensitivity to operating frequencies for the computing unit executing the draw calls. On the other hand, when a difference between the first number of clock cycles and the second number of clock cycles is proportional to the difference between the first operating frequency and the second operating frequency, this may indicate a lower performance sensitivity to changes in operating frequencies. In such a scenario, the performance may be dependent on one or more external factors other than operating frequency, such as memory access latency, number of CPU or GPU cores, data links, and the like. Each long draw call in a distinct scene, in an implementation, may have a specific performance sensitivity to changes in operating frequencies, ranging from lowest performance sensitivity to highest performance sensitivity, as described above.

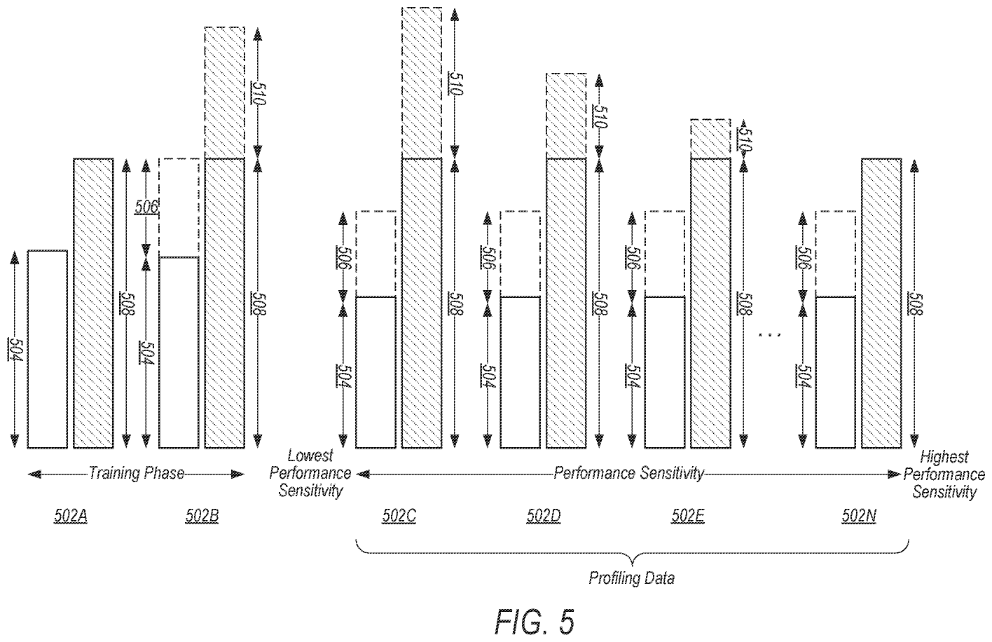

Turning now to FIG. 5, an exemplary spectrum of performance sensitivities to operating frequencies for a plurality of draw calls, is illustrated. As shown, the spectrum illustrates various draw calls 502A-N having varied performance sensitivity to changes in operating frequencies, ranging from a lowest performance sensitivity to a highest performance sensitivity.

In the figure, operating frequency during execution of a given draw call is illustrated using bars 504, and changes in the operating frequency are illustrated using bars 506 with dotted borders. Similarly, number of clock cycles consumed during execution of a given draw call is illustrated using bars 508 and changes in the number of clock cycles are illustrated using bars 510 with dotted borders.

As described in conjunction with FIGS. 2 and 4, a system management unit (e.g., system management unit 210) operates in a training phase and an optimization phase. In the training phase, performance sensitivities of tasks to changes in operating frequencies is determined. This information is stored as profiling data. In the optimization phase, the determined performance sensitivities are used to optimize frequency in order to affect performance and power consumption for one or more computing units. Although FIG. 5 is described in conjunction with profiling of one or more draw calls to collect profiling data about performance sensitivities of the one or more draw calls to operating frequencies, in several other implementations, other tasks may be profiled for a plurality of operating parameters. Such implementations are contemplated.

In the training phase, the system management unit identifies one or more long draw calls (such as draw calls 502A and 502B) and profiles the long draw calls to determine clock cycles consumed during execution of the draw calls and how the number of clock cycles is affected with changes in the operating frequencies. In an implementation, a given draw call 502 is identified as a long draw call when the execution of the draw call 502 is predicted to take a number of clock cycles that is greater than or equal to a clock cycle threshold. Further, in another implementation, the draw call 502 can also be identified as a long draw call based on a CRC value associated with a shader program defining execution instructions for the draw call 502. In an implementation, a CRC (cyclic redundancy check) value is used to identify and validate a specific shader program. The shader CRC value may be calculated by applying a hashing algorithm (or some other algorithm) to the shader program's source code or compiled bytecode. The resulting hash value is a unique, fixed-size representation of the shader that can be used to accurately verify the integrity of the shader program. In addition to being used for verification and integrity checking, shader CRC values can also be used to optimize the performance of shader programs by allowing the renderer to quickly determine whether a given shader has already been compiled and can be reused, or whether it needs to be recompiled.

In the example shown in FIG. 5, for the draw call 502A, the system management unit determines the number of clock cycles 508 consumed during its execution at a first operating frequency 504, and save this information. Such information may be saved in a local buffer and may be saved in any of a variety of data structures such as a data array or otherwise. During this determination, frequency changes are disabled, i.e., the operating frequency 504 remains unchanged, as shown. Once the draw call 502A is profiled, i.e., the number of clock cycles 508 consumed during execution of the draw call 502A is determined, the frequency optimizations can be enabled again. That is, the system management unit can enable modifications in operating frequencies 504 for subsequent draw calls. A subsequent similar draw call (e.g., another long draw call 502B) queued for execution is then identified. In an implementation, a draw call 502 may have processing characteristics similar to another draw call 502 due to temporal locality. For instance, consecutive frames in a scene may be substantially similar due to a relatively small number of changes between the frames. Consequently, execution of a given frame is expected to be similar (e.g., consume a similar amount of processing and data resource, take a similar amount of time, etc.) to that of an immediately preceding frame when the scene is unchanged. The temporal locality between frames allows the system management unit to profile draw calls 502 during the training phase and generate the profiling data, such that the profiling data can then be used to predict processing characteristics of one or more subsequent frames within a given scene. When a change in scene is identified, a new training phase can be retriggered.

For the draw call 502B, the system management unit increases the operating frequency 504 by a threshold percentage (shown by bar 506 with dotted boundaries) for execution of the draw call 502B. In other examples, the operating frequencies 504 can also be decreased. Based on this change in the operating frequency, the system management unit determines the resultant changes (or lack thereof) to the number of clock cycles consumed during the execution of the draw call 502B, with respect to that of draw call 502A. In an example shown, the change in the number of clock cycles 508 for draw call 502B, in comparison to draw call 502A, is depicted using bar 510 with dotted border. This comparison, i.e., how the number of clock cycles 508 for a given draw call 502B is affected in comparison to a similar draw call 502A, responsive to changes in the operating frequency 504, is used to determine performance sensitivities for each of the plurality of draw calls 502 to changes in operating frequencies 504, as shown.

For example, a spectrum of performance sensitivity for each draw call 502, ranging from a lowest performance sensitivity to highest performance sensitivity is generated based on the information available for previously profiled draw calls 502A and 502B, and the performance sensitivities is stored as profiling data. In the example shown, draw call 502C can have the lowest performance sensitivity to operating frequencies 504, since the change in number of clock cycles 508 (represented by bar 510) is directly proportional to changes in operating frequencies 504 (represented by bar 506). That is, for draw calls having temporal locality with draw call 502C, the execution performance is likewise expected to be independent of changes in operating frequencies and therefore modification to operating frequencies may not have any tangible effect on the performance.

On the other end of the spectrum, i.e., for draw call 502N, the performance sensitivity to operating frequencies may be highest since change in the operating frequencies (represented by bar 506) does not result in any change in the number of clock cycles 508 consumed. That is, for draw call 502 N, the system management unit can increase the operating frequencies 504 in order to decrease the execution time, thereby increasing the performance in execution. Further, for draw calls having temporal locality with draw call 502N, if power savings are desired, the operating frequencies 504 may be decreased, although this may decrease the performance as well.

As shown in the figure, the system management unit can profile draw calls 502 to determine performance sensitivity as a relationship between operating frequencies 504 and number of clock cycles 508. The profiled draw calls can then serve as reference operating point(s) for other similar draw calls, e.g., other draw calls in the same frame or another frame of the same scene. Further, each time a scene changes (or any other training condition is met), the system management unit may retrigger the training phase and update the profiling data.

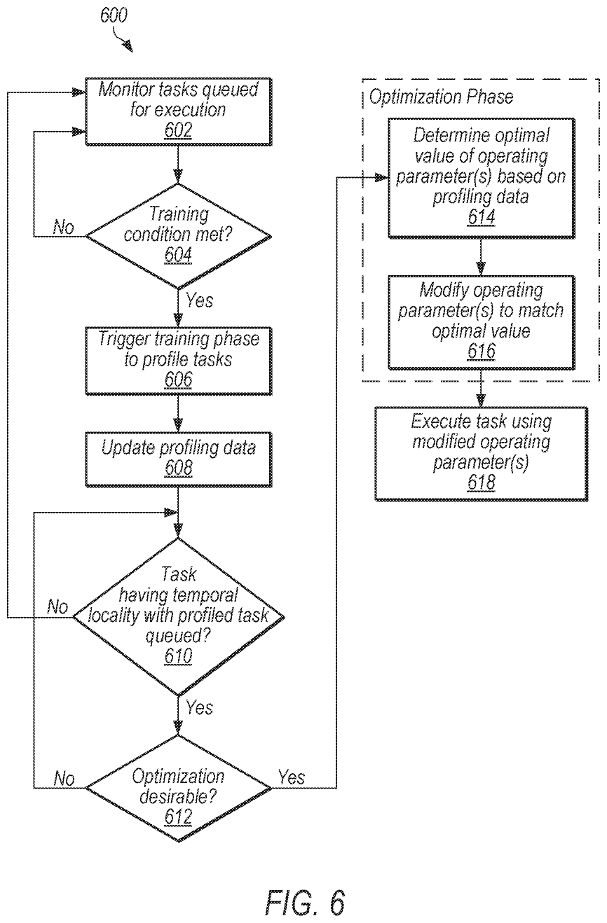

FIG. 6 illustrates an exemplary method 600 for optimizing operating parameters for execution of one or more tasks. As described in the foregoing, a system management unit is configured to optimize operating parameters of a computing units scheduled to execute a plurality of tasks. The operating parameters are optimized based at least in part on profiling data generated by profiling two or more tasks in a training phase. Using the profiling data, the system management unit optimizes parameters for subsequent tasks having a temporal locality with the profiled two or more tasks.

Referring to the method 600, the system management unit can monitor tasks queued for execution (block 602). In an example, a task can include a draw call for execution during rendering of a frame in a scene. Other examples are contemplated. Based on monitoring the tasks, the system management unit determines whether a training condition is met for a given task (conditional block 604). In one implementation, when the task is a draw call, a training condition is met when a given draw call has not been profiled before and the execution of which is predicted to consume a number of clock cycles greater than or equal to a cycle threshold value. In another implementation, a training condition can also be met if a frame length of a current frame differs from a previously rendered frame by a threshold value. Other training conditions are contemplated.

In an implementation, a given scene comprises frames such that a large number of consecutive frames are similar to one another. Further, profiling data generated in response to successful profiling of a given draw call during rendering of a frame can be used for other frames. Further, responsive to change in the scene (e.g., as indicated by a change in length of time to render a frame, a marker included in the data, or otherwise) a training condition is deemed to be met. Other implementations of training conditions are contemplated.

If the training condition is not met (conditional block 604, “no” leg), the system management unit continues to monitor queued tasks until a training condition is determined to be met. When the training condition is met (conditional block 604, “yes” leg), the system management unit triggers a training phase to profile the task (block 606). In the example where the task is a draw call, the system management unit profiles the draw call at a first operating frequency. Further, a subsequent (e.g., consecutive) draw call is profiled by the system management unit by calculating a number of clock cycles consumed during execution of the draw call at a second operating frequency different than the first operating frequency. The system management unit then determines whether the number of clock cycles for the draw call has changed (i.e., increased or decreased) in comparison to the number of clock cycles consumed for the previously executed draw call. This comparison of clock cycles between the two draw calls indicates a performance sensitivity of the draw call to the operating frequency. If there is no (or little) change, the draw call is deemed to have no (or low) sensitivity to operating frequency changes. If there is a change, the draw call will be deemed to have a sensitivity that is proportional to the change (e.g., a large change indicates a large sensitivity, a moderate change indicates a moderate sensitivity, and so on).

The performance sensitivity for each draw call, along with information pertaining to operating frequencies and consumed clock cycles is stored by the system unit as profiling data. Each time the training phase is retriggered (i.e., any training condition is met), the system management unit is configured to update the profiling data (block 608). Once the training phase is complete, the system management unit determines whether a task having temporal locality (i.e., relatively similar to) with at least one previously profiled task is queued for execution (conditional block 610). If no such task has been queued (conditional block 610, “no” leg), the method 600 continues to block 602 where the system management unit can keep monitoring new tasks. Otherwise, if a task having a temporal locality with at least one previously profiled task is queued for execution (conditional block 610, “yes” leg), the system management unit further determines whether optimization of one or more operating parameters for the queued task is desirable (conditional block 612). In an implementation, optimization of operating parameters can be necessitated in order to save power and/or increase performance while execution of a given task. For example, the operating frequency of a computing unit when executing tasks that have low performance sensitivity (or relatively lower sensitivity to other tasks) to clock frequencies may be dropped from an initial value, in order to save power. In another example, for a computing unit executing tasks that are compute-bound, the system management unit can increase the clock frequency to improve performance. On the other hand, for memory-bound tasks, the system management unit does not increase the frequency given that such an increase does not result in an increased (or desired increase) in performance. Other scenarios necessitating optimizations to operating parameters are contemplated.

If such optimizations are not necessitated (conditional block 612, “no” leg), the method continues to block 610 wherein the system management unit proceeds to monitor for tasks having temporal locality with one or more previously profiled tasks. However, if optimizations are necessitated, the system management unit begins operations in an optimization mode. In the optimization mode, the system management unit is configured to identify an optimal value of at least a given operating parameter, e.g., operating frequency for execution of a draw call (block 614). In an implementation, the optimal value may be identified, or otherwise determined, based at least in part on performance sensitivities represented in the profiling data associated with one or more previously profiled tasks. Based on the determination, the system management unit can then modify a current value of the given operating parameter to match the optimal value (block 616) or otherwise be closer to the optimal value. In other implementations, the system management unit can also utilize the optimal value as a threshold for modifying the operating parameter. The queued task can then be executed at the modified operating parameter (618).

In various implementations, when the operating parameter is an operating frequency and the system management unit is not operating in the optimization phase, a given computing unit may consume available power in order to maximize performance. In other words, if it is determined a power credit (i.e., “unused power”) exists, this credit is reported to the given unit. In response to detecting that a power credit is available, the operating frequency of the given unit may increase in order to take advantage of the excess power that is available. In such an implementation, the given unit selects various operating frequencies based on reported available power. Such reported available power can represent currently unused power that has accumulated, or previously accumulated power that was unused. For instance, if the optimization mode is disabled, and a power credit exists (e.g., allocated power remains available that permits operating at a higher frequency), the computing unit operates at operating frequencies that are closer to a maximum allowable frequency, rather than operating at throttled values of operating frequencies. With the optimization mode, however, this extra available power can be saved, since the operating frequencies can be throttled using the optimal values as threshold. That is, based at least in part on previously profiled tasks, the system management unit is able to throttle the operating frequencies of subsequent tasks and thereby save additional power as power credits. This additional power can subsequently be utilized for tasks where better performance is desirable.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a system management circuit configured to:
monitor execution of a first task using a first operating frequency;
monitor execution of a second task using a second operating frequency different from the first operating frequency; and
select a third operating frequency for use in executing a third task, based at least in part on a comparison of a sensitivity of the first task to the first operating frequency to a sensitivity of the second task to the second operating frequency.

2. The system as recited in claim 1, wherein the comparison comprises comparing a first number of clock cycles used to execute the first task to a second number of clock cycles used to execute the second task.

3. The system as claimed in claim 2, wherein the system management circuit is configured to select the third operating frequency for executing the third task such that it is closer to the second operating frequency than a current operating frequency, responsive to the first number of clock cycles being substantially equal to the second number of clock cycles.

4. The system as claimed in claim 2, wherein the system management circuit is configured to select the third operating frequency for executing the third task such that it is closer to the first operating frequency than a current operating frequency, responsive to the first number of clock cycles not being substantially equal to the second number of clock cycles.

5. The system as claimed in claim 1, wherein each of the first task, the second task, and the third task comprise draw calls for rendering frame data.

6. The system as claimed in claim 5, wherein the system management circuit is configured to distinguish between the draw calls based at least in part on a cycle redundancy check value associated with a shader program that corresponds to each draw call.

7. The system as claimed in claim 6, wherein a cyclic redundancy check value for a draw call is obtained via instrumentation associated with a corresponding shader block.

8. The system as claimed in claim 7, wherein the system management circuit is configured to use runtime low-power controller firmware to monitor execution of the first task and the second task, and select the third operating frequency.

9. A method comprising:
executing a first task using a first operating frequency;
executing a second task using a second operating frequency different from the first operating frequency; and
selecting, by a system management circuit, a third operating frequency for use in executing a third task, based at least in part on a comparison of a sensitivity of the first task to the first operating frequency to a sensitivity of the second task to the second operating frequency.

10. The method as recited in claim 9, wherein the comparison comprises comparing, by the system management circuit, a first number of clock cycles used to execute the first task to a second number of clock cycles used to execute the second task.

11. The method as claimed in claim 10, further comprising selecting, by the system management circuit, the third operating frequency for executing the third task such that it is closer to the second operating frequency than a current operating frequency, responsive to the first number of clock cycles being substantially equal to the second number of clock cycles.

12. The method as claimed in claim 10, further comprising modifying, by the system management circuit, the third operating frequency for executing the third task such that it is closer to the first operating frequency than a current operating frequency, responsive to the first number of clock cycles not being substantially equal to the second number of clock cycles.

13. The method as claimed in claim 9, wherein each of the first task, the second task, and the third task comprise draw calls for rendering frame data.

14. The method as claimed in claim 13, further comprising distinguishing between the draw calls based at least in part on a cycle redundancy check value associated with a shader program that corresponds to each draw call.

15. The method as claimed in claim 9, further comprising profiling the first task and the second task during runtime to generate profiling data, wherein profiling the first task and the second task at least comprises the comparison.

16. The method as claimed in claim 9, further comprising using a runtime low-power controller firmware to determine frequency in relation to power consumption for executing the first task and the second task.

17. A processing unit comprising:
one or more compute units configured to execute tasks; and
circuitry configured to:
monitor execution of a first task executed by a compute unit of the one or more compute units while using a first operating frequency;
monitor execution of a second task executed by a compute unit of the one or more compute units while using a second operating frequency different from the first operating frequency; and
select a third operating frequency for use in executing a third task, based at least in part on a comparison of a sensitivity of the first task to the first operating frequency to a sensitivity of the second task to the second operating frequency.

18. The processing unit as claimed in claim 17, wherein the circuitry is configured to: monitor execution of the first task and the second task during a training phase, and select the third operating frequency during an optimization phase.

19. The processing unit as claimed in claim 18, wherein the circuitry is configured to store profile data for each of the first task and the second task during the training phase.

20. The processing unit as claimed in claim 19, wherein the circuitry is configured to identify the third operating frequency during the optimization phase.
